(19) United States
(12) Patent Application Publication
(10) Pub. No.: US 2011/0173319 A1
(43) Pub. Date: Jul. 14, 2011

(54) APPARATUS AND METHOD FOR OPERATING SERVER USING VIRTUALIZATION TECHNIQUE

(75) Inventors: Ki Ryong HA, Daejeon (KR); Jeun Woo LEE, Daejeon (KR)

(73) Assignee: Electronics and Telecommunications Research Institute, Daejeon (KR)

(21) Appl. No.: 13/005,556

(22) Filed: Jan. 13, 2011

(30) Foreign Application Priority Data
Jan. 13, 2010 (KR) 10-2010-0003113

(51) Int. Cl. G06F 15/173

(52) U.S. Cl. 709/224; 709/226

(57) ABSTRACT

An apparatus for operating a server using a virtualization technique includes: a system managing unit for registering a virtual server performing a service, assigning and cancelling physical hardware resources in response to a command of a manager, and managing resource assigning policies to be applied depending on services; and a virtual resource managing unit for managing information on physical hardware and a virtual operating system. The apparatus further includes a virtual server managing unit for executing the virtual operating system using physical hardware resources, assigning a virtual server processing a service to the virtual operating system, and executing the virtual server to monitor resource assignment to the operated virtual server, when a designated service is requested over a network.

### CROSS-REFERENCE(S) TO RELATED APPLICATION

The present invention claims priority of Korean Patent Application No. 10-2010-0003113, filed on Jan. 13, 2010, which is incorporated herein by reference.

### FIELD OF THE INVENTION

The present invention relates to a technique of virtualizing a server, and more particularly, to an apparatus and method for operating a server using a virtualization technique, which are suitable for operating a server by a dynamic loading method in a service unit using a virtualization technique.

### BACKGROUND OF THE INVENTION

Recently, as a virtualization technique of separating physical hardware components from an operating system is generalized, a large number of Internet data centers are increasing the efficiency of server management by using a virtualization solution. Most of servers operated on the existing Internet are equipped with physical devices of high performance considering connections with possible maximum users. Therefore, in a normal situation, the operations of the servers use much smaller physical hardware resources than the total physical hardware resource. Actually, the use amount of the CPU resources of average servers is between 10% and 20%, which is very low.

Therefore, the server virtualization technique allows multiple operating systems to be operated in one hardware component and at the same time allows the amount of physical hardware resources assigned to the corresponding operating systems to be dynamically controlled so that respective hardware components may be operated with high efficiency. This increase in the performance efficiency actually reduces the number of practical and physical hardware components that need to be operated at a time, thus increasing the efficiency of management and reducing costs.

In particular, the use of a sensor network and establishment of a ubiquitous environment such as u-city require various kinds of services to be provided through a server and an increase in the devices that are always connected to a network such as a smart phone leads to an explosive increase in the kinds of server-client based services. Such services are not steadily required due to the characteristics thereof. Rather, the demand for the services may not be accurately estimated and the services are irregularly required. Thus, it becomes difficult to use the server providing the services in an efficient way.

Therefore, in order to provide various kinds of services, efficiently managing the servers and minimizing the use of resources based on the efficient management of the servers are considered as important tasks with the advent of a green IT technique. In particular, with the development of the virtualization technique, as it becomes possible to separate the hardware components from the operating system and to dynamically control the physical hardware resources assigned to a specific operating system, it becomes possible to separate the services from the hardware components and the operating system as well as to simply make the operating system independent.

### SUMMARY OF THE INVENTION

Therefore, the present invention provides an apparatus and method for operating a server using a virtualization technique which are capable of actively operating servers in units of services by using a virtualization technique to maximize the efficiency of the server operation, to thereby provide various kinds of services using minimum physical hardware resources.

The present invention further provides an apparatus and method for operating a server using a virtualization technique, which are capable of dynamically assigning physical hardware resources at the point of time when services are required, to thereby establish an active virtualization infra based on the services and flexibly cope with a change in the amount of use of resources required for the services.

In accordance with an aspect of the present invention, there is an apparatus for operating a server using a virtualization technique. The apparatus includes: a system managing unit for registering a virtual server performing a service, assigning and cancelling physical hardware resources in response to a command of a manager, and managing resource assigning policies to be applied depending on services; a virtual resource managing unit for managing information on physical hardware and a virtual operating system; and a virtual server managing unit for executing the virtual operating system using physical hardware resources, assigning a virtual server processing a service to the virtual operating system, and executing the virtual server to monitor resource assignment to the operated virtual server, when a designated service is requested over a network.

In accordance with another aspect of the present invention, there is provided a method of operating a server using a virtualization technique. The method includes: receiving information on a server to be operated; monitoring whether a service request corresponding to the server is received based on the received information on the server; analyzing the received service request to execute a virtual server when the service request is received; and checking a status of the executed server to dynamically assign resources.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating the structure of an apparatus for operating a server using a virtualization technique in accordance with an embodiment of the present invention; and

FIG. 2 illustrates a flowchart describing an operation procedure of the server operating apparatus using a virtualization technique in accordance with the embodiment of the present invention.

### DETAILED DESCRIPTION OF THE EMBODIMENT

In accordance with an embodiment of the present invention, in order to maximize the efficiency of server operation, the servers are dynamically operated in units of services by using a virtualization technique to provide various kinds of services using minimum physical hardware resources. Therefore, it is possible to provide a method of managing the servers not in units of virtual operating systems provided by conventional virtualizing solutions but in units of servers in which the services are actually provided, based on the fact that the units in which a user recognizes the services when the user requests to receive the services through the Internet are not the operating systems but the services, thereby increasing management efficiency and actively coping with a change in the request of the user.

Therefore, in the embodiment of the present invention, there is provided a method in which the manager operates the system in units of the servers, with the entire system operated based on the servers that provide the services.

In addition, the fact that one server typically operates in one operating system in order to prevent a server from colliding with another server that performs another function allows this approach to be more effectively performed.

For example, an authentication server that provides login and authentication functions and a media server that provides an image streamed and transmitted to a user are respectively operated in different operating systems so that, when one server has a problem, the other server is not affected.

Hereinafter, the embodiment of the present invention will be described in detail with reference to the accompanying drawings which form a part hereof.

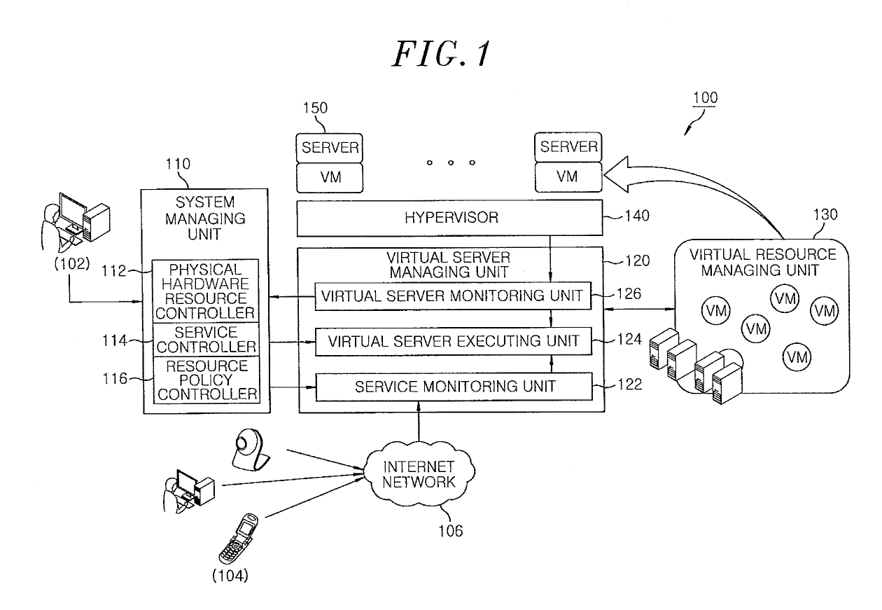

FIG. 1 is a block diagram illustrating the configuration of an apparatus for operating a server by using a virtualization technique in accordance with the embodiment of the present invention.

Referring to FIG. 1, when a manager inputs information on a server to be operated, a server operating apparatus 100 using a virtualization technique monitors whether the service corresponding to the server is requested based on the input information, analyzes the input service request to execute a server 150, and checks the status of the executed server 150 to dynamically assign resources. The server operating apparatus 100 includes a system managing unit 110, a virtual server managing unit 120, a virtual resource managing unit 130, a hypervisor 140, and the server 150. The virtual server managing unit 120 includes a service monitoring unit 122, a virtual server executing unit 124, and a virtual server monitoring unit 126.

The system managing unit 110 registers or cancels a virtual server to be operated by the virtual server monitoring unit 122 and determines a resource assigning policy to be applied depending on the service. The system managing unit 110 includes a physical hardware resource controller 112, a service controller 114, and a resource policy controller 116. Since the system managing unit 110 may be executed by receiving a control command of the manager, a web interface environment or a graphic user interface (GUI) environment is provided to the manager so that server information can be easily registered.

The physical hardware resource controller 112 manages addition and deletion of physical hardware resources such as a CPU, memory and the like. The service controller 114 manages addition, deletion, and setting of a virtual operating system. The resource policy controller 116 manages information on the server performing the service and includes the resource assigning policies to be applied depending on services.

At this point, information on the server may be largely divided into \textcircled{1} the connection information of the service of which the server will be in charge (for example, an IP address, a port number, and the type of protocol), \textcircled{2} the maximum and minimum values of physical hardware resources such as a CPU, a memory, and a disk required for operating the server and the operating policy of the physical hardware resources, and \textcircled{3} information on the virtual operating system on which the server operates.

The virtual server managing unit 120 manages a virtual server and includes a service monitoring unit 122, a virtual server executing unit 124, and a virtual server monitoring unit 126.

The service monitoring unit 122 monitors a service request from a network, e.g., an Internet 106 to know whether there are service requests of clients 104 for the service predetermined through the system managing unit 110.

The virtual server executing unit 124 operates a virtual operating system by using the physical hardware resources managed by the virtual resource managing unit 130 according to the service requested by the service monitoring unit 122 from the client 104 and assigns the virtual server 150 to be executed for processing the service to the operated virtual operating system.

The hypervisor 140 assigns physical hardware resources to the virtual server 150 executed through the virtual server executing unit 124 on the hardware to actually operate them. The virtual server monitoring unit 126 checks a resource use status and operation statuses of the servers that are currently being executed through the hypervisor 140.

The virtual resource managing unit 130, which manages information on the physical devices forming a computer, has information on available physical hardware resources and an image of a virtual operating system. Therefore, the virtual resource managing unit 130 provides the information on the physical hardware resource and that of the virtual operating system to the virtual server executing unit 124 in association with each other.

The service monitoring unit 122 monitors an IP address and a port number within a certain range and monitors service requests which come to the corresponding IP address and the port number. Upon request of a service, when the requested service coincides with the content predetermined by the system managing unit 110, the corresponding information is transferred to the virtual server executing unit 124. The virtual server executing unit 124 receives information on the service received by the service monitoring unit 122 from the system managing unit 110 to execute a server 150 corresponding to the requested service. In this process, the availability of the physical hardware resources in the virtual resource managing unit 130 is confirmed to select suitable physical hardware resources and the virtual operating system to be operated using the corresponding physical hardware resources is selected.

At this time, the physical hardware resources and the virtual operating system are selected based on the status of the resources that exist in the virtual resource managing unit 130 and the resource assigning policy in units of the services input through the system managing unit 110.

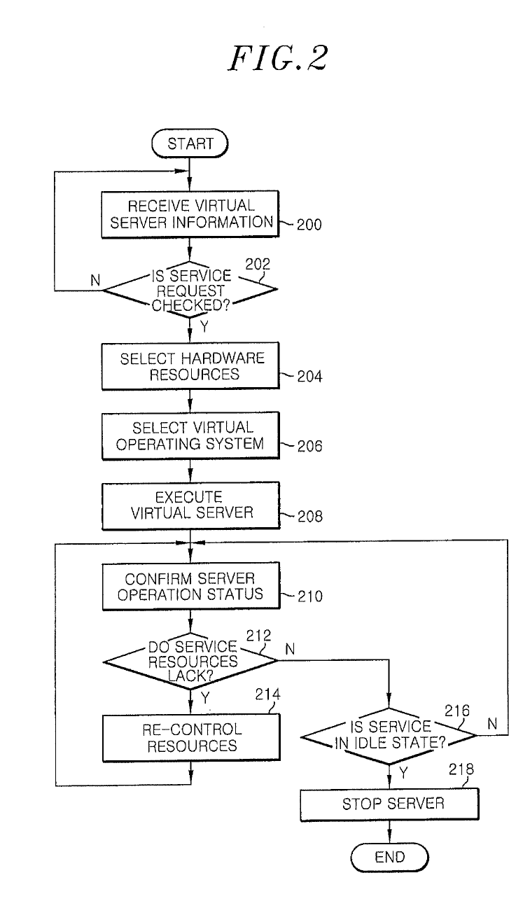

FIG. 2 illustrates a flowchart describing an operation procedure of the server operating apparatus using a virtualization technique in accordance with the embodiment of the present invention.

Referring to FIG. 2, in step 200, the server operating apparatus 100 using the virtualization technique is operated based on the information on the virtual server input by the manager 102. That is, when the manager 102 inputs services to be operated by the system and information on servers for actually processing the respective services, in a next step 202 the service monitoring unit 122 starts to monitor whether there are service requests.

In monitoring the service request, it is monitored whether there are connection requests from the clients 104 using the Internet network 106 for an IP address and a port number within a designated range. When the connection request of a designated service is received, the process of the present invention proceeds to step 204. In step 204, the virtual server executing unit 124 receives the connection request information, and the availability of the physical hardware resources in the virtual resource managing unit 130 is confirmed to select suitable physical hardware resources. In this step, the virtual server executing unit 124 checks the level of the resources requested by the server 105, a server operating policy, and the status of the resources that exist in the virtual resource managing unit 130 to select physical hardware resources. Then, in step 206, a virtual operating system is selected.

The virtual operating system is operated by using the selected physical hardware resources. In step 208, the virtual server 150 is executed using the operated virtual operating system. Then, in step 210, the statuses of the servers that are being operated are checked through the hypervisor 140.

If it is determined in step 212 that there is lack of resources in the virtual server 150 being executed, the process proceeds to step 214, in which the resources are rearranged to satisfy the server operating policy. When the operating status of the virtual server 150 is monitored periodically, the process returns from step 214 to step 210.

Meanwhile, if it is determined in step 212 that there is no lack of resources of the virtual server 150, the process proceeds to step 216 to determine whether the virtual server 150 is in an idle state. If it is determined that the virtual server 150 is in the idle state, the process goes to step 218 to cancel the physical hardware resources assigned to the corresponding virtual server 150 and stop the operation of the virtual server 150 until additional service request is received. Then, the process proceeds to the end. Alternatively, after the operation of the virtual server 150 is stopped, the process may return to the step 202.

However, if it is determined in step 216 that the virtual server 150 is not in the idle state, meaning that it is normally operated, the process returns to the step 210 to monitor the operation status of the virtual server 150 at a predetermined time later.

As described above, in the apparatus for operating a server using the virtualization technique in accordance with the embodiment of the present invention and the method thereof, the virtual server that may process the corresponding service is operated at a time point when the service request is generated, and the server is stopped and the assigned physical hardware resources are cancelled at a time point when there is no service request, thereby maximizing the efficiency of use of the resources. In addition, the resources assigned to the servers are actively controlled based on the operating policies of the respective servers, thereby establishing an active virtualization infra based on the service.

Further, in the state that a plurality of media servers, file servers, and web servers needs to be operated on the virtual operating system, the respective servers operate at the time point when the requests of the clients are generated and the assigned resources to each server are put down when there is no service request for a predetermined period of time, thus allowing the other servers to use the corresponding resources.

This enables various types of servers to efficiently operate based on minimum physical hardware resources in an Internet enterprise or a web portal system that operates multiple services. If a new Internet service starts and the new service is accessed by relatively many users, in case of using a conventional access method, additional hardware needs to be purchased considering a maximum amount of access. However, when the server operation method using the virtualization technique in accordance with the present invention is used, in case where access is concentrated on a specific server, the virtual server monitoring unit collects the resources left in the other virtual servers and assigns them to the new server, thereby solving the problems in the prior art.

Since, in this approach, all of the resources are canceled when there is no service request for a predetermined period of time, the method is more effective, particularly when the service is intermittently requested at random time intervals. Further, the server operation method using the virtualization technique can be applied to an automatic operating system based on an event such as a monitoring system than in case where the user directly accesses the server like the web server.

In particular, in the ubiquitous environment, various kinds of services such as u-city, u-health, and u-traffic are operated based on the network. The clients often request a specific service at the point of time when an event is generated. In this case, the method in which the server operates at the point of time when the service request is generated to process the same is effective in comparison with the case in which the server is always standby to thus occupy the resources.

In accordance with the apparatus and method for operating a server using a virtualization technique of the present invention, the server that can process the corresponding service is operated at the point of time when the service are required, thereby maximizing the efficiency of use of resources. In addition, it is possible to flexibly cope with the resources required for the service by dynamically assigning the physical hardware resources.

While the invention has been shown and described with respect to the particular embodiments, it will be understood by those skilled in the art that various changes and modification may be made without departing from the scope of the invention as defined in the following claims.

What is claimed is:

1. An apparatus for operating a server using a virtualization technique, comprising:
a system managing unit for registering a virtual server performing a service, assigning and cancelling physical hardware resources in response to a command of a manager, and managing resource assigning policies to be applied depending on services;
a virtual resource managing unit for managing information on physical hardware and a virtual operating system; and
a virtual server managing unit for executing the virtual operating system using physical hardware resources, assigning a virtual server processing a service to the virtual operating system, and executing the virtual server to monitor resource assignment to the operated virtual server, when a designated service is requested over a network.

2. The apparatus of claim 1, wherein the system managing unit includes:
a physical hardware resource controller for assigning or cancelling physical hardware resources in response to a command of the manager;
a service controller for adding or cancelling services; and
a resource policy controller for designating a size and a range of resources required for a corresponding service.

3. The apparatus of claim 2, wherein the system managing unit provides a web interface or a graphic user interface (GUI) to the manager.

4. The apparatus of claim 1, wherein the virtual resource managing unit manages information on physical hardware forming a computing device and generates an image of the virtual operating system to assign the physical hardware to the virtual operating system.

5. The apparatus of claim 1, wherein the virtual server managing unit includes:
a service monitoring unit for monitoring whether the designated service is requested;
a virtual server executing unit for executing a virtual operating system registered in the system managing unit depending on a service requested through the service monitoring unit, and assigning and executing the virtual server so that the executed virtual operating system can process the service; and
a virtual server monitoring unit for monitoring a status of a virtual server being executed and controlling an amount of resource assignment based on the monitored status.

6. The apparatus of claim 5, wherein the service monitoring unit monitors an IP address and a port number within a predetermined range to monitor whether a service request is received from a client corresponding to the IP address and the port number designated by the system managing unit.

7. The apparatus of claim 5, wherein the virtual server executing unit executes the virtual server using the information on the physical hardware and the virtual operating system provided by the virtual resource managing unit and process the service request found by the service monitoring unit.

8. The apparatus of claim 5, wherein the virtual server monitoring unit confirms availability of the physical hardware resources used by the virtual server being executed, and actively assigns and cancels the resources when there is lack of resources or when the resources are left.

9. The apparatus of claim 5, wherein the virtual server monitoring unit cancels the assigned physical hardware resources and stops operating the virtual server when the virtual server being executed is in an idle state.

10. The apparatus of claim 1, further comprising:
a hypervisor for assigning the physical hardware resources to the virtual server and executing the physical hardware resources.

11. A method of operating a server using a virtualization technique, comprising:
receiving information on a server to be operated;
monitoring whether a service request corresponding to the server is received based on the received information on the server;
analyzing the received service request to execute a virtual server when the service request is received; and
checking a status of the executed server to dynamically assign resources.

12. The method of claim 11, wherein said monitoring monitors an IP address and a port number within a predetermined range to monitor whether a service request is received from a client corresponding to the IP address and the port number included in the designated service.

13. The method of claim 11, wherein said analyzing the received service request to execute a virtual server executes the virtual server using the physical resources and the virtual operating system.

14. The method of claim 13, wherein said analyzing the received service request to execute a virtual server generates the virtual operating system and assigns the physical resources to the generated virtual operating system.

15. The method of claim 13, wherein said analyzing the received service request to execute a virtual server executes a pre-registered virtual operating system depending on the requested service, and assigns and executes the virtual server so that the executed virtual operating system can process the service.

16. The method of claim 11, wherein said checking a status of the executed server to dynamically assign resources checks availability of the physical hardware resources used by the virtual server being executed, and actively assigns and cancels the resources when there is lack of resources lack or when the resources are left.

17. The method of claim 11, wherein said checking a state of the executed server cancels the assigned physical hardware resources and stops operating the virtual server when the virtual server being executed is in an idle state.

18. The method of claim 11, wherein said analyzing the received service request assigns the physical hardware resources to the virtual server and executes the physical hardware resources by using a hypervisor.
